(19) United States
(12) Patent Application Publication
(10) Pub. No.: US 2006/0284576 A1
(43) Pub. Date: Dec. 21, 2006

(54) Backlight control circuit

(75) Inventors: Kun Le, Shenzhen (CN); Tong Zhou, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/455,918

(22) Filed: Jun. 19, 2006

(30) Foreign Application Priority Data
Jun. 17, 2005 (TW) 94120180

(51) Int. Cl. H05B 39/00

(52) U.S. Cl. 315/312

(57) ABSTRACT

An exemplary backlight control circuit (200) includes two backlight inspecting circuits (210), a pulse width modulation integrated circuit (PWM IC) (250) having a current sampling pin (251), a first transistor (271), and an input circuit (230). Each backlight inspecting circuit includes a backlight (211) and an output end (212). The input circuit includes a second transistor (233), a resistor (232), and two diodes (231). The source electrodes of the first and second transistors grounded. The drain electrode of the first transistor is connected to the current sampling pin. The gate electrode of the first transistor and the drain electrode of the second transistor are connected to a power supply. The gate electrode of the second transistor and the positive terminals of the diodes are connected to the power supply via the resistor. The negative terminals of the diodes are respectively connected to the output ends of the backlight inspecting circuit.

### FIELD OF THE INVENTION

The present invention relates to a backlight control circuit typically used in a liquid crystal display (LCD).

### GENERAL BACKGROUND

An LCD has the advantages of portability, low power consumption, and low radiation, and has been widely used in various portable information products such as notebooks, personal digital assistants (PDAs), video cameras and the like. Furthermore, the LCD is considered by many to have the potential to completely replace CRT (cathode ray tube) monitors and televisions.

A typical LCD includes an LCD panel, a plurality of backlights for illuminating the LCD panel, an inverter circuit for driving the backlight, and a backlight control circuit including a pulse width modulation integrated circuit (PWM IC) for driving the inverter circuit. Generally, the backlight control circuit further includes a backlight protecting circuit, for stopping operation of the PWM IC when any one of the backlights has an open circuit or a short circuit connecting to ground.

FIG. 2 is an abbreviated diagram of a typical backlight control circuit used in the LCD. The backlight control circuit 100 includes four backlight inspecting circuits 110, a pulse width modulation integrated circuit (PWM IC) 150, and a backlight protection circuit (not labeled). The backlight protection circuit includes a first transistor 171, a current limiting resistor 172, and an input circuit 130.

Each backlight inspecting circuit 110 includes a backlight 111 and an output end 112. The output end 112 provides a high voltage when the corresponding backlight 111 works. The output end 112 provides a low voltage when the corresponding backlight 111 has an open circuit or a short circuit connecting to ground.

The PWM IC 150 includes a current sampling pin 151. The PWM IC 150 stops working if the current sampling pin 151 has a low voltage.

The first transistor 171 includes a source electrode “s”, a drain electrode “d” and a gate electrode “g”. The source electrode “s” is connected to ground. The drain electrode “d” is connected to the current sampling pin 151 of the PWM IC 150. The gate electrode “g” is connected to a power supply via a current limiting resistor 172. The power supply is provided by a power pin (not labeled) of the PWM IC 150.

The input circuit 130 includes four diodes 131, four resistors 132, four capacitors 135, a second transistor 1332, a third transistor 1333, a fourth transistor 1334, and a fifth transistor 1335. Each transistor 1332, 1333, 1334, 1335 includes a source electrode “s”, a drain electrode “d” and a gate electrode “g”. The drain electrode “d” of the second transistor 1332 is connected to the gate electrode “g” of the first transistor 171. The drain electrode “d” of the third transistor 1333 is connected to the source electrode “s” of the second transistor 1332. The drain electrode “d” of the fourth transistor 1334 is connected to the source electrode “s” of the third transistor 1333. The drain electrode “d” of the fifth transistor 1335 is connected to the source electrode “s” of the fourth transistor 1334. The source electrode “s” of the fifth transistor 1335 is connected to ground. The gate electrodes “g” of the second, third, fourth, and fifth transistors 1332, 1333, 1334, 1335 are connected to the negative terminals of the four diodes 131, respectively. The positive terminals of the four diodes 131 are respectively connected to the output ends 112 of the backlight inspecting circuits 110. Each of the gate electrodes “g” of the second, third, fourth, and fifth transistors 1332, 1333, 1334, 1335 is connected to ground via the corresponding resistor 132, and is connected to ground via the corresponding capacitor 135.

The first transistor 171, the second transistor 1332, the third transistor 1333, the fourth transistor 1334 and the fifth transistor 1335 are negative-channel metal oxide semiconductor (NMOS) type transistors.

The operation of the backlight control circuit 100 is as follows. When all the backlights 111 work normally, each of the output ends 112 provides a high voltage to the corresponding gate electrode “g” of the second, third, fourth, and fifth transistor 1332, 1333, 1334, 1335 via the corresponding diode 131. Then the second, third, fourth, and fifth transistors 1332, 1333, 1334, 1335 are switched to an activated state, and the gate electrode “g” of the first transistor 171 is connected to ground via the activated second, third, fourth, and fifth transistors 1332, 1333, 1334, 1335. Thus the first transistor 171 is turned off, and the current sampling pin 151 of the PWM IC 150 maintains an original working voltage.

When any one of the backlights 111 has an open circuit or has a short circuit connecting to ground, the corresponding output end 112 provides a low voltage to the corresponding gate electrode “g” of the second, third, fourth, and fifth transistors 1332, 1333, 1334, 1335 via the corresponding diode 131. Then the corresponding second, third, fourth, or fifth transistor 1332, 1333, 1334, 1335 is turned off, so that the gate electrode “g” of the first transistor 171 is charged to a high voltage via the current limiting resistor 172. Thus the first transistor 171 is switched to an activated state, and the current sampling pin 151 of the PWM IC 150 is connected to ground via the activated first transistor 171. Consequently, the current sampling pin 151 of the PWM IC 150 is charged to a low voltage, and the PWM IC 150 stops working.

The backlight control circuit 100 includes the five transistors 171, 1332, 1333, 1334, 1335 needed to carry out the function of protecting the backlights 111. Further, the number of transistors needed increases with the number of backlights 111 used in the LCD. Consequently, the cost of the backlight control circuit 100 is high, particularly in the case where the number of backlights 111 is large.

It is desired to provide a backlight control circuit used typically in an LCD which overcomes the above-described deficiencies.

### SUMMARY

In a preferred embodiment, a backlight control circuit includes at least two backlight inspecting circuits, a PWM IC including a current sampling pin, a first transistor, an input circuit. Each backlight inspecting circuit includes a backlight and an output end. The input circuit includes a second transistor, a resistor, and at least two diodes. The source electrodes of the first and second transistors are connected to ground. The drain electrode of the first transistor is connected to the current sampling pin of the PWM IC. The gate electrode of the first transistor and the drain electrode of the second transistor are connected to a power supply. The gate electrode of the second transistor and the positive terminals of the diodes are connected to the power supply via the resistor. The negative terminals of the diodes are respectively connected to the output ends of the backlight inspecting circuits.

Advantages and novel features of the above-described circuits will become more apparent from the following detailed description when taken in conjunction with the accompanying drawings.

### BRIEF DESCRIPTION OF THE DRAWINGS

FIG. 1 is an abbreviated diagram of a backlight control circuit according to a preferred embodiment of the present invention, the backlight control circuit typically used in an LCD.

FIG. 2 is an abbreviated diagram of a conventional backlight control circuit used in an LCD.

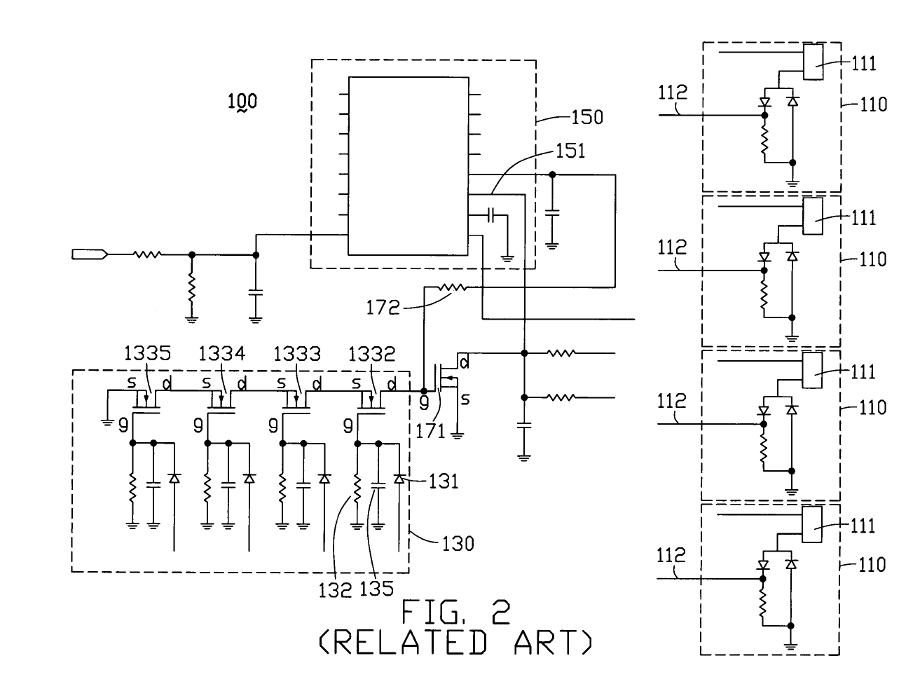

### DETAILED DESCRIPTION OF PREFERRED EMBODIMENTS

Reference will now be made to the drawings to describe the present invention in detail.

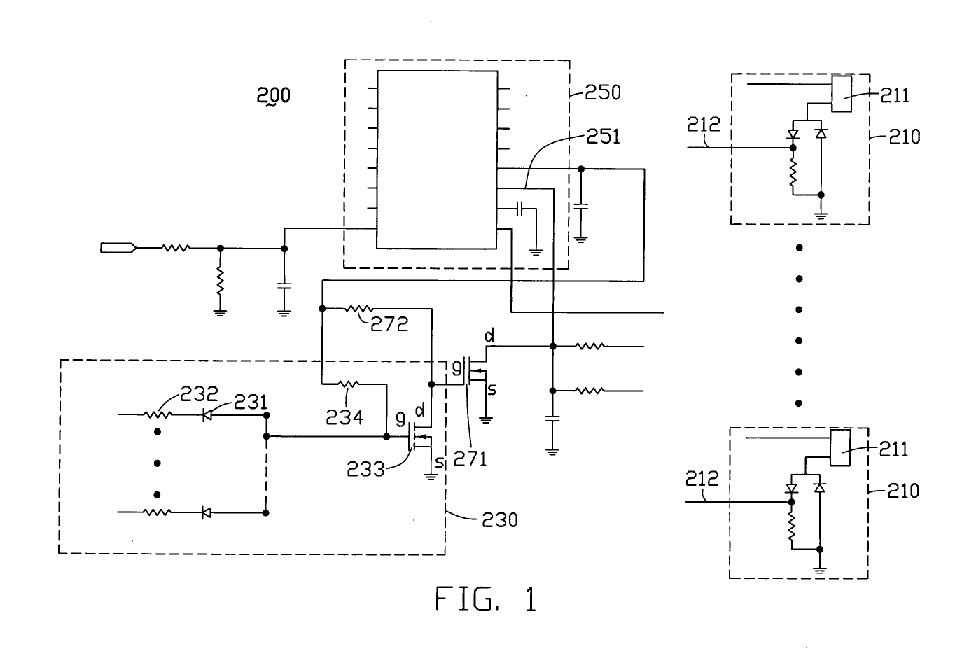

FIG. 1 is an abbreviated diagram of a backlight control circuit according to a preferred embodiment of the present invention, the backlight control circuit typically being used in an LCD. The backlight control circuit 200 includes a plurality of backlight inspecting circuits 210, a PWM IC 250, and a backlight protection circuit (not labeled). The backlight protection circuit includes a first transistor 271 and an input circuit 230. Only two backlight inspecting circuits 210 are illustrated, and unless the context indicates otherwise, in the following description it will be assumed that there are only backlight inspecting circuits 210.

Each backlight inspecting circuit 210 includes a backlight 211 and an output end 212. The output end 212 provides a high voltage when the corresponding backlight 211 works. The output end 212 provides a low voltage when the corresponding backlight 211 has an open circuit or a short circuit connecting to ground.

The PWM IC 250 includes a current sampling pin 251. The PWM IC 250 stops working if the current sampling pin 251 has a low voltage.

The first transistor 271 includes a source electrode “s”, a drain electrode “d”, and a gate electrode “g”. The source electrode “s” of the first transistor 271 is connected to ground. The drain electrode “d” of the first transistor 271 is connected to the current sampling pin 251 of the PWM IC 250. The gate electrode “g” of the first transistor 271 is connected to a power supply via a current limiting resistor 272. The power supply is provided by a power pin (not labeled) of the PWM IC 250.

The input circuit 230 includes a second transistor 233, a resistor 234, a plurality of diodes 231, and a plurality of voltage division resistor 232. Only two diodes 231 and two voltage division resistors 232 are illustrated, and unless the context indicates otherwise, in the following description it will be assumed that there are only two diodes 231 and two voltage division resistors 232. The second transistor 233 includes a source electrode “s”, a drain electrode “d” and a gate electrode “g”. The negative terminals of the two diodes 231 are respectively connected to the two output ends 212 of the backlight inspecting circuits 210 via two respective voltage division resistors 232. The positive terminals of the two diodes 231 and the gate electrode “g” of the second transistor 233 are all connected to the power supply via the resistor 234. The drain electrode “d” of the second transistor 233 is connected to the gate electrode “g” of the first transistor 271. The source electrode “s” of the second transistor 233 is connected to ground.

The diodes 231 can for example be SN4148 type diodes. A resistance of each voltage division resistor 232 is larger than 8KΩ, and preferably is 10KΩ. A resistance of the resistor 234 is preferably 6.8 KΩ. The PWM IC 250 can for example be an OZ9910G type PWM IC. The first transistor 271 and the second transistor 233 can be negative-channel metal oxide semiconductor (NMOS) type transistors or negative positive negative (NPN) type transistors.

Generally, operation of the backlight control circuit 200 is as follows. When the backlight 211 of any one of the backlight inspecting circuits 210 works, the output end 212 of the backlight inspecting circuit 210 provides a high voltage to the gate electrode “g” of second transistor 233 via the corresponding voltage division resistor 232 and the corresponding diode 231 in that order. Then the second transistor 233 is switched to be in an activated state, and the gate electrode “g” of the first transistor 271 is connected to ground via the activated second transistor 233. Thus, the first transistor 271 is turned off, and the current sampling pin 251 of the PWM IC 250 maintains an original working voltage.

When any one of the backlights 211 has an open circuit or a short circuit connecting to ground, the output end 212 of the corresponding backlight inspecting circuit 210 provides a low voltage to the gate electrode “g” of second transistor 233 via the corresponding voltage division resistor 232 and the corresponding diode 231 in that order. Then the second transistor 233 is turned off, so that the gate electrode “g” of the first transistor 271 is charged to a high voltage by the power supply. Thus the first transistor 271 is switched to be in an activated state, so that the current sampling pin 251 of the PWM IC 250 is connected to ground via the activated first transistor 271. Then the current sampling pin 251 of the PWM IC 250 is discharged to a low voltage, and the PWM IC 250 stops working.

The backlight control circuit 200 needs only two transistors 271, 233 to carry out the function of protecting the backlights 211, no matter how many backlights 211 the backlight control circuit 200 has. Therefore, the backlight control circuit 200 has low cost.

It is to be understood, however, that even though numerous characteristics and advantages of the preferred embodiments have been set out in the foregoing description, together with details of the structures and functions of the embodiments, the disclosure is illustrative only; and that changes may be made in detail, especially in matters of shape, size, and arrangement of parts within the principles of present invention to the full extent indicated by the broad general meaning of the terms in which the appended claims are expressed.

What is claimed is:

1. A backlight control circuit comprising:
at least two backlight inspecting circuits, each of which comprises a backlight and an output end;
a pulse width modulation integrated circuit (PWM IC) comprising a current sampling pin;
a first transistor, a source electrode of the first transistor being connected to ground, a drain electrode of the first transistor being connected to the current sampling pin of the PWM IC, and a gate electrode of the first transistor being connected to a power supply; and
an input circuit comprising a second transistor, a resistor, and at least two diodes, negative terminals of the diodes being respectively connected to the output ends of the backlight inspecting circuits, positive terminals of the diodes and a gate electrode of the second transistor being connected to the power supply via the resistor, a drain electrode of the second transistor being connected to the gate electrode of the first transistor, and a source electrode of the second transistor being connected to ground.

2. The backlight control circuit as claimed in claim 1, wherein the input circuit further comprises at least two voltage division resistors, and the negative terminal of each diode is connected to the output end of the corresponding backlight inspecting circuit via a corresponding one of the voltage division resistors.

3. The backlight control circuit as claimed in claim 2, wherein a resistance of the resistor of the input circuit is approximately equal to 6.8KΩ.

4. The backlight control circuit as claimed in claim 3, wherein a resistance of each of the voltage division resistors is greater than 8KΩ.

5. The backlight control circuit as claimed in claim 4, wherein resistance of each of the voltage division resistors is approximately equal to 10KΩ.

6. The backlight control circuit as claimed in claim 2, further comprising a current limiting resistor via which the gate electrode of the first transistor is connected to the power supply.

7. The backlight control circuit as claimed in claim 1, wherein at least one of the first and the second transistors is a negative-channel metal oxide semiconductor (NMOS) type transistor.

8. The backlight control circuit as claimed in claim 1, wherein at least one of the first and the second transistors is a negative positive negative (NPN) type transistor.

9. A backlight control circuit comprising:
at least two backlight inspecting circuits, each of which comprises a backlight and an output end;
a pulse width modulation integrated circuit (PWM IC) comprising a current sampling pin; and
first and second transistor connected to each other in series, source electrodes of both said first and second transistor connected to ground, a drain electrode of the first transistor connected to the PWM IC while that of the second transistor connected to a gate electrode of the first transistor, the gate electrode of the second transistor is connected to pairs of resistors and diodes; wherein
said pairs are arranged in a parallel relation with one another

10. The backlight control circuit as claimed in claim 10, wherein both said gate electrodes connected to a power supply via respective resistors.
